(19) United States
(12) Patent Application Publication
(10) Pub. No.: US 2013/0089784 A1
(43) Pub. Date: Apr. 11, 2013

(54) NEGATIVE ACTIVE MATERIAL AND LITHIUM BATTERY CONTAINING THE NEGATIVE ACTIVE MATERIAL

(71) Applicants: Yu-Jeong Cho, Yongin-si (KR); So-Ra Lee, Yongin-si (KR); Ha-Na Yoo, Yongin-si (KR); Ui-Song Do, Yongin-si (KR); Chang-Su Shin, Yongin-si (KR); Su-Kyung Lee, Yongin-si (KR); Jae-Myung Kim, Yongin-si (KR)

(72) Inventors: Yu-Jeong Cho, Yongin-si (KR); So-Ra Lee, Yongin-si (KR); Ha-Na Yoo, Yongin-si (KR); Ui-Song Do, Yongin-si (KR); Chang-Su Shin, Yongin-si (KR); Su-Kyung Lee, Yongin-si (KR); Jae-Myung Kim, Yongin-si (KR)

(21) Appl. No.: 13/553,743

(22) Filed: Jul. 19, 2012

(30) Foreign Application Priority Data
Oct. 5, 2011 (KR) 10-2011-0101437

(51) Int. Cl. H01M 4/583; H01M 4/40; H01M 4/46; H01M 4/42; H01M 4/44; H01M 4/62; H01M 4/60; H01M 4/38; B82Y 30/00

(52) U.S. Cl. 429/213; 429/231.8; 429/231.6; 429/226; 429/231.5; 429/229; 429/222; 429/224; 429/223; 429/221; 429/220; 429/219; 429/217; 977/948; 977/734; 977/742

(57) ABSTRACT

A negative active material and a lithium battery including the negative active material. The negative active material includes primary particles, each including: a crystalline carbonaceous core having a surface on which silicon-based nanowires are disposed; and an amorphous carbonaceous coating layer that is coated on the crystalline carbonaceous core so as not to expose at least a portion of the silicon-based nanowires. Due to the inclusion of the primary particles, an expansion ratio is controlled and conductivity is provided and thus, a formed lithium battery including the negative active material may have improved charge-discharge efficiency and cycle lifespan characteristics.

### RELATED APPLICATIONS

This application claims priority to and the benefit of Korean Patent Application No. 10-2011-0101437, filed on Oct. 5, 2011, in the Korean Intellectual Property Office, the disclosure of which is incorporated herein in its entirety by reference.

### BACKGROUND

1. Field

One or more embodiments of the present invention relate to a negative active material and a lithium battery including the negative active material.

2. Description of the Related Art

Lithium secondary batteries used in portable electronic devices for information communication (such as PDAs, mobile phones, or notebook computers), electric bicycles, electric vehicles, or the like have a discharge voltage that is at least twice as high as that of a conventional battery and thus have high energy density.

Lithium secondary batteries generate electric energy by oxidation and reduction reactions occurring when lithium ions are intercalated into or deintercalated from a positive electrode and a negative electrode, each including an active material that enables intercalation and deintercalation of lithium ions, with an organic electrolytic solution or a polymer electrolytic solution interposed between the positive electrode and the negative electrode.

As a positive active material for lithium secondary batteries, for example, an oxide that includes lithium and a transition metal and has a structure enabling intercalation of lithium ions may be used. Examples of such an oxide are a lithium cobalt oxide (LiCoO₂), a lithium nickel oxide (LiNiO₂), a lithium nickel cobalt manganese oxide (Li[NiCoMn]O₂ or Li[Ni_{1-x-y}CoₓM_{y}]O₂), etc.

As a negative active material, a carbonaceous base material and a non-carbonaceous base material, which enable intercalation or deintercalation of lithium ions, are used and studies thereon have been continuously performed. Examples of a carbonaceous base material are artificial graphite, natural graphite, and hard carbon. An example of a non-carbonaceous base material is Si.

A non-carbonaceous base material has a very high capacity that is 10 times greater than that of graphite. However, due to a volumetric expansion and contraction during charging and discharging, capacity retention ratio, charge/discharge efficiency, and lifetime (lifespan) characteristics thereof may be degraded. Accordingly, there is a need to develop a high performance negative active material with improved efficiency and lifespan characteristics.

### SUMMARY

An aspect of one or more embodiments of the present invention is directed toward a negative active material with improved capacity characteristics and cycle lifespan characteristics.

An aspect of one or more embodiments of the present invention is directed toward a lithium battery including the negative active material.

Additional aspects will be set forth in part in the description which follows and, in part, will be apparent from the description, or may be learned by practice of the presented embodiments.

According to one or more embodiments of the present invention, a negative active material includes a primary particle. The primary particle includes: a crystalline carbonaceous core with silicon-based nanowires disposed on a surface thereof; and an amorphous carbonaceous coating layer that is coated on the crystalline carbonaceous core so as not to expose at least a portion of the silicon-based nanowires.

According to an embodiment of the present invention, at least 50 vol % of the silicon-based nanowires may be embedded in the amorphous carbonaceous coating layer.

According to one or more embodiments of the present invention, a thickness of the amorphous carbonaceous coating layer may be in a range of about 0.1 to about 10 μm.

According to one or more embodiments of the present invention, a D/G ratio of the amorphous carbonaceous coating layer may be 0.31 or more, wherein the D/G ratio is a ratio of a D (defect) band peak intensity area with respect to a G (graphite) band peak intensity area in a Raman spectrum.

According to one or more embodiments of the present invention, the amorphous carbonaceous coating layer may include an amorphous carbon selected from the group consisting of soft carbon (cold calcination carbon), hard carbon, pitch carbide, mesophase carbide, calcined corks, and combinations thereof.

According to one or more embodiments of the present invention, an amount of the amorphous carbonaceous coating layer may be in a range of about 0.1 to about 30 wt % based on the primary particle.

According to an embodiment of the present invention, the crystalline carbonaceous core may have a circularity of about 0.2 to about 1. For example, the circularity may be in a range of about 0.7 to about 1, or about 0.8 to about 1, or about 0.9 to about 1.

According to an embodiment of the present invention, the carbonaceous material may include a pore or pores therein, and a porosity thereof may be in a range of about 5 to about 30%.

According to an embodiment of the present invention, a D/G ratio of the crystalline carbonaceous core may be 0.3 or less, wherein the D/G ratio is a ratio of a D (defect) band peak intensity area with respect to a G (graphite) band peak intensity area in a Raman spectrum.

The crystalline carbonaceous core may include at least one of natural graphite, artificial graphite, expandable graphite, graphene, carbon black, and fullerene soot.

According to an embodiment of the present invention, an average particle diameter of the crystalline carbonaceous core may be in a range of about 1 to about 30 μm.

According to an embodiment of the present invention, the silicon-based nanowires may include at least one of Si, SiOx (0<x≦52), and Si—Z alloys (where Z is an alkali metal, an alkali earth metal, a Group 13 element, a Group 14 element, a transition metal, a rare earth element, or a combination thereof and is not Si). For example, the silicon-based nanowires may be Si nanowires.

According to an embodiment of the present invention, each of the silicon-based nanowires independently may have a diameter of about 10 to about 500 nm and a length of about 0.1 to about 100 μm.

According to an embodiment of the present invention, the silicon-based nanowires may be directly grown on the crystalline carbonaceous core. In this regard, the silicon-based nanowires may be grown in the presence or absence of at least one metal catalyst selected from the group consisting of Pt, Fe, Ni, Co, Au, Ag, Cu, Zn, and Cd.

According to an embodiment of the present invention, based on a total amount of the crystalline carbonaceous core and the silicon-based nanowires, an amount of the crystalline carbonaceous core may be in a range of about 60 to about 99 wt % and an amount of the silicon-based nanowires may be in a range of about 1 to about 40 wt %.

According to an embodiment of the present invention, the negative active material may further include a carbonaceous particle including at least one of natural graphite, artificial graphite, expandable graphite, graphene, carbon black, fullerene soot, carbon nanotubes, and carbon fiber. Herein, the carbonaceous particle may be in a spherical, tabular, fibrous, tubular, or powder form.

According to one or more embodiments of the present invention, a lithium battery includes: a negative electrode including the negative active material; a positive electrode that is disposed facing the negative electrode; and an electrolyte disposed between the negative electrode and the positive electrode.

The negative active material included in the negative electrode may be the same as described above.

According to an embodiment of the present invention, the negative electrode may further include at least one binder selected from the group consisting of polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrilebutadienestyrene, phenol resin, epoxy resin, polyethylenetelethphalate, polytetrafluoroethylene, polyphenylsulfide, polyamideimide, polyetherimide, polyethylenesulfone, polyamide, polyacetal, polyphenyleneoxide, polybutylenetelephthalate, ethylene-propylene-diene terpolymer (EPDM), sulfonated EPDM, styrene butadiene rubber, and a fluoride rubber. An amount of the binder may be in a range of about 1 to about 50 parts by weight based on 100 parts by weight of the negative active material. For example, the amount of the binder may be in a range of 1 to 30 parts by weight, 1 to 20 parts by weight, or 1 to 15 parts by weight, based on 100 parts by weight of the negative active material.

The negative electrode may further include at least one conductive agent of carbon black, acetylene black, ketjen black, carbon fiber, copper, nickel, aluminum, silver, and a conductive polymer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a primary particle included in a negative active material according to an embodiment of the present invention;

FIG. 2 is a schematic view of a lithium battery according to an embodiment of the present invention;

FIGS. 3A and 3B show field emission scanning electron microscope (FE-SEM) images of a cross-section of a negative active material used in manufacturing a coin cell according to Example 1;

FIGS. 4A and 4B show FE-SEM images of a negative active material used in manufacturing a coin cell according to Comparative Example 1;

FIG. 5 shows Raman spectrum analysis results of a negative active material used in the coin cell of Example 1;

FIG. 6 shows particle size distribution measurement results of negative active materials used in manufacturing coin cells according to Examples 1-4 and Comparative Example 1;

FIG. 7 shows electric conductivity measurement results of the coin cells of Example 1 and Comparative Example 1;

FIG. 8 shows pH measurement results of negative electrodes of the coin cells of Examples 1-4 and Comparative Example 1;

FIG. 9 shows a result of measuring a volumetric expansion ratio of a negative electrode when the coin cells of Examples 1-4 and Comparative Example 1 are charged and discharged;

FIGS. 10A and 10B show graphs of a charge-discharge efficiency (CDE) of the coin cells of Examples 1-4 and Comparative Example 1; and

FIGS. 11A and 11B show graphs of a capacity retention ratio (CRR) of the coin cells of Examples 1-4 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, one or more embodiments of the present invention are described in more detail.

A negative active material according to an embodiment of the present invention includes a primary particle including a crystalline carbonaceous core with silicon-based nanowires disposed on a surface thereof, and an amorphous carbonaceous coating layer that is coated on the crystalline carbonaceous core so as not to expose at least a portion of the silicon-based nanowires.

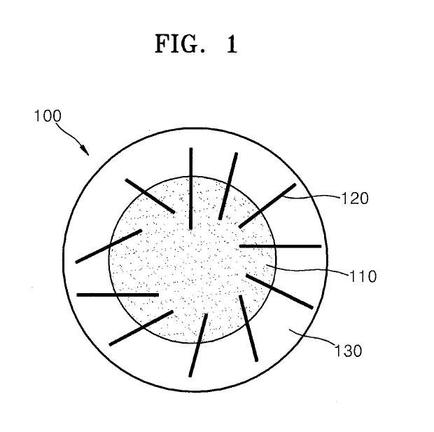

FIG. 1 is a schematic view of a primary particle 100 included in a negative active material according to an embodiment of the present invention. Referring to FIG. 1, the primary particle 100 of the negative active material includes a crystalline carbonaceous core 110 with silicon-based nanowires 120 disposed on a surface thereof and an amorphous carbonaceous coating layer 130 coated on the crystalline carbonaceous core 110 so as not to expose at least a portion of the silicon-based nanowires 120.

The term “carbonaceous” included in the crystalline carbonaceous core 110 refers to inclusion of at least about 50 wt % of carbon. For example, the crystalline carbonaceous core may include at least about 60 wt %, 70 wt %, 80 wt %, or 90 wt % of carbon, or may include only 100 wt % of carbon.

Also, the term “crystalline” refers to inclusion of at least about 50 wt % of a hexagonal crystal lattice structure in which a carbon atom that forms a sp² hybrid orbital is covalently bonded to three other carbon atoms. For example, the crystalline carbonaceous core 110 may include carbon having about 60 wt %, about 70 wt %, about 80 wt %, or about 90 wt % of the hexagonal crystal lattice structure, or may include only carbon having about 100 wt % of the hexagonal crystal lattice structure. The hexagonal crystal lattice structure may form a single- or multi-layer structure, or based on a 2-dimensional shape, may have various deformation shapes, such as a curved shape, a curled shape, a partially defected shape, or the like. Also, many hexagonal crystal lattice structures may be connected to form a soccer ball shape. A crystal structure of the crystalline carbonaceous core 110 is not limited as long as lithium ions are reversibly intercalated or deintercalated during charging and discharging. For example, a plane interval (d002) of a (002) plane due to X-ray diffraction of the crystalline carbonaceous core 110 may be equal to or greater than 0.333 nm and less than 0.339 nm, for example, equal to or greater than 0.335 nm and less than 0.339 nm, or equal to or greater than 0.337 nm and equal to or less than 0.338 nm.

According to an embodiment of the present invention, the crystalline carbonaceous core 110 may include natural graphite, artificial graphite, expandable graphite, graphene, carbon black, fullerene soot, or a combination thereof, but examples thereof is not limited thereto. Natural graphite is graphite that is naturally formed, and examples thereof are flake graphite, high crystalline graphite, microcrystalline, cryptocrystalline, amorphous graphite, etc. Artificial graphite is graphite that is artificially synthesized, and is formed by heating amorphous carbon at high temperature, and examples thereof are primary or electrographite, secondary graphite, graphite fiber, etc. Expandable graphite is graphite that is formed by intercalating a chemical material, such as an acid or alkali, between graphite layers, followed by heating to swell a vertical layer of a molecular structure. Graphene refers to a single layer of graphite. Carbon black is a crystalline material that has less regular structure than graphite, and when carbon black is heated at a temperature of about 3,000° C. for a long period of time, the carbon black may turn into graphite. Fullerene soot refers to a carbon mixture including at least 3 wt % of fullerene that is a polyhedron bundle that is composed of 60 or more carbon atoms. The carbonaceous core may include one of these crystalline carbonaceous materials or a combination of two or more thereof. For example, natural graphite may be used because an assembly density is easily increased when manufacturing a negative electrode.

According to an embodiment of the present invention, a D/G ratio of the crystalline carbonaceous core 110 may be 0.3 or less, wherein the D/G ratio is a ratio of a D (defect) band peak intensity area with respect to a G (graphite) band peak intensity area in a Raman spectrum. For example, in the Raman spectrum, the D/G ratio of the crystalline carbonaceous core 110 may be in a range of about 0.1 to about 0.3. In one embodiment, if the D/G ratio is equal to or less than 0.3, the carbonaceous core 110 has crystallinity, and thus, an irreversible reaction of lithium ions is reduced or minimized during charging and discharging and a reversible efficiency may be increased.

According to an embodiment of the present invention, the crystalline carbonaceous core 110 may be spherical. The term “spherical” used herein refers to a case in which at least a portion of the carbonaceous core 110 has a gently or sharply curved external shape. The carbonaceous base material may have a complete spherical shape, an incomplete spherical shape, or an oval shape. It may further have an uneven surface.

A degree of roundness of the carbonaceous core 110 may be confirmed by measuring a circularity thereof. Circularity refers to a measurement value indicating how much the measured shape differs from a complete circle and has a range of 0 to 1. Thus, if the circularity is closer to 1, the measured shape is more circular. According to an embodiment of the present invention, a circularity of the carbonaceous core 110 may be in a range of about 0.2 to about 1, or about 0.7 to about 1, or about 0.8 to about 1, or about 0.9 to about 1.

The spherical carbonaceous core 110 may contribute to determining the shape of a primary particle, and compared to a tabular, plate-shaped or lump-shaped carbonaceous core, the carbonaceous core 110 is not orientated in a particular direction during pressing (press-molding), and is suitable for high-rate discharge characteristics, low-temperature characteristics, or the like. Also, a specific surface area of the carbonaceous core 110 is reduced and thus reactivity with an electrolytic solution is decreased. Thus, a formed lithium battery has improved cyclic characteristics.

For example, such a spherical crystalline carbonaceous core 110 may be prepared by performing a spheroidizing treatment of a crystalline carbonaceous material, such as natural graphite, artificial graphite, expandable graphite, graphene, carbon black, fullerene soot, etc. For example, a spherical carbonaceous core obtained by a spheroidizing treatment of graphite may have a microstructure, in which layered graphite may be gently or sharply curved, or may have a microstructure that is composed of a plurality of gently or sharply curved graphite scales or a plurality of graphite thin films.

According to an embodiment of the present invention, when the carbonaceous core 110 is formed in a spherical shape through the spheroidizing treatment, the carbonaceous core 110 may have a pore or pores therein. The pore present inside the carbonaceous core 110 may contribute to a decrease in volumetric expansion of silicon-based nanowires during charging and discharging. According to an embodiment of the present invention, the carbonaceous core 110 may have a porosity of about 5 to about 30%, for example, about 10 to about 20%, based on a total volume of the carbonaceous core.

An average particle size of the carbonaceous core 110 may not be limited. However, if the average particle size of the carbonaceous core 110 is too small, reactivity with an electrolytic solution is too high and thus cyclic characteristics of a formed lithium battery may be degraded. On the other hand, if the average particle size of the carbonaceous core 110 is too large, dispersion stability in preparing a negative electrode slurry is decreased and a formed negative electrode may have a rough surface. For example, an average particle diameter of the carbonaceous core 110 may be in a range of about 1 to about 30 μm. For example, the average particle diameter of the carbonaceous core 110 may be in a range of about 5 to about 25 μm, for example, about 10 to about 20 μm.

The carbonaceous core 110 may function as a support for fixing the silicon-based nanowires 120 and may also suppress a volumetric change of the silicon-based nanowires 120 during charging and discharging.

The silicon-based nanowires 120 are disposed on a surface of the carbonaceous core 110. In this regard, the term “silicon-based” used herein refers to inclusion of at least about 50 wt % of silicon (Si), for example, at least about 60 wt %, about 70 wt %, about 80 wt %, or about 90 wt % of Si, or may include only 100 wt % of Si. Also, in this regard, the term “nanowire” used herein refers to a wire structure having a nano-diameter cross-section. For example, the nanowire may have a cross-section diameter of about 10 to about 500 nm and a length of about 0.1 to about 100 μm. Also, an aspect ratio (length:width) of each nanowire may be 10 or more, for example, 50 or more, or for example, 100 or more. Also, diameters of nanowires may be substantially identical to or different from each other, and from among longer axes of nanowires, at least a portion may be linear, gently or sharply curved, or branched. Such silicon-based nanowires may withstand a volumetric change of a lithium battery due to charging and discharging.

The silicon-based nanowires 120 may include, for example, at least one of Si, SiOx (0<x≦2), and Si—Z alloys (where Z is an alkali metal, an alkali earth metal, a Group 13 element, a Group 14 element, a transition metal, a rare earth element, or a combination thereof and is not Si), but a material for forming the silicon-based nanowires 120 is not limited thereto. The element Z may be selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and combinations thereof. Also, Si, SiOₓ, and the alloy of Si and Z may include amorphous silicon, crystalline (including single or poly crystalline) silicon, or a combination thereof. The silicon-based nanowires 120 may include these materials alone or in a combination. For example, Si nanowires may be used as the silicon-based nanowires 120 in consideration of high capacity.

The silicon-based nanowires 120 may be manufactured by directly growing silicon-based nanowires on the carbonaceous core 110, or by disposing, for example, attaching or coupling silicon-based nanowires which have been grown separately to the carbonaceous core 110. The silicon-based nanowires 120 may be disposed on the carbonaceous core 110 by using any known placing methods. For example, a nanowire may be grown by using vapor-liquid-solid (VLS) growth method, or using a nano-sized catalyst that thermally decomposes a precursor gas present nearby. The silicon-based nanowires 120 may be directly grown on the carbonaceous core 110 in the presence or absence of a metal catalyst. Examples of the metal catalyst are Pt, Fe, Ni, Co, Au, Ag, Cu, Zn, Cd, etc.

According to an embodiment of the present invention, based on the total amount of the crystalline carbonaceous core 110 and the silicon-based nanowires 120, an amount of the crystalline carbonaceous core 110 may be in a range of about 60 to about 99 wt % and an amount of the silicon-based nanowires 120 may be in a range of about 1 to about 40 wt %. Due to the inclusion of this amount range of high-capacity silicon-based nanowires, a high-capacity negative active material may be obtained.

The amorphous carbonaceous coating layer 130 is coated on the crystalline carbonaceous core 110 with the silicon-based nanowires 120 disposed on a surface thereof so as not to expose at least a portion of the silicon-based nanowires 120. The term “amorphous” refers to a case in which a distinctive crystal structure is not present. The amorphous carbonaceous coating layer 130 may include, for example, at least about 50 wt %, about 60 wt %, about 70 wt %, about 80 wt %, or about 90 wt % of amorphous carbon, or may include 100 wt % of amorphous carbon.

According to an embodiment of the present invention, a D/G ratio of the amorphous carbonaceous coating layer 130 may be 3.0 or more, wherein the D/G ratio is a ratio of a D (defect) band peak intensity area with respect to a G (graphite) band peak intensity area in a Raman spectrum. For example, in the Raman spectrum, the D/G ratio of the amorphous carbonaceous coating layer 130 may be in a range of 3.0 to 4.0, for example, 3.1 to 3.6, 3.1 to 3.2, or 3.3 to 3.6. These D/G ratio values are distinguished from those of the crystalline carbonaceous core 110.

According to an embodiment of the present invention, the amorphous carbonaceous coating layer 130 may be formed in such a way that at least 50 vol % of the silicon-based nanowires 120 are embedded in the amorphous carbonaceous coating layer 130. For example, at least 60 vol %, 70 vol %, 80 vol %, or 90 vol % of the silicon-based nanowires 120 are embedded in the amorphous carbonaceous coating layer 130, or the silicon-based nanowires 120 may be completely embedded not to be exposed to a surface of the primary particle.

The amorphous carbonaceous coating layer 130 prevents (or protects from) separation or elimination of the silicon-based nanowires 120 during charging and discharging, thereby contributing to stability of an electrode and an increase of a lifespan of an electrode. Also, the amorphous carbonaceous coating layer 130 may provide electric conductivity for the negative active material, of which an electric conductivity has been reduced due to the silicon-based nanowires 120, and improve efficiency characteristics.

According to an embodiment of the present invention, the amorphous carbonaceous coating layer 130 may include soft carbon (cold calcination carbon), hard carbon, pitch carbonized material, mesophase carbonized material, calcined corks, or a combination thereof.

A coating method for the amorphous carbonaceous coating layer 130 may be, but is not limited to, dry coating or liquid coating. Examples of the dry coating are deposition, chemical vapor deposition (CVD), etc, and examples of the liquid coating are impregnation, spraying, etc. For example, the crystalline carbonaceous core 110 on which the silicon-based nanowires 120 are disposed may be coated with a carbon precursor, such as a coal-based pitch, a mesophase pitch, a petroleum-based pitch, a coal-based oil, a petroleum-based crude oil, an organic synthetic pitch, or a polymer resin, such as a phenol resin, a furan resin, a polyimide resin, or the like, followed by heat treating to form the amorphous carbonaceous coating layer 130.

The amorphous carbonaceous coating layer 130 may be formed in such a thickness that the amorphous carbonaceous coating layer 130 provides a sufficient conductive passage between primary particles without a decrease in battery capacity. For example, the thickness of the amorphous carbonaceous coating layer 130 may be in a range of about 0.1 to about 10 μm, for example, about 0.5 to about 10 μm, or about 1 to about 5 μm, but is not limited thereto.

According to an embodiment of the present invention, an amount of the amorphous carbonaceous coating layer 130 may be in a range of about 0.1 to about 30 wt % based on the primary particle. For example, an amount of the amorphous carbonaceous coating layer 130 may be in a range of about 1 to about 25 wt %, or 5 to 25 wt %, based on the primary particle. Within the range described above, the amorphous carbonaceous coating layer 130 may have an appropriate thickness, and may provide conductivity to a negative active material.

According to an embodiment of the present invention, the primary particle may be agglomerated or combined with each other to form a secondary particle, or may be combined with other active components to form a secondary particle.

According to an embodiment of the present invention, the negative active material may further include, together with the primary particles, a carbonaceous particle including at least one of natural graphite, artificial graphite, expandable graphite, graphene, carbon black, fullerene soot, carbon nanotubes, and carbon fiber. In this regard, the carbonaceous particle may be included in a spherical, tabular, fibrous, tubular, or powder form. For example, the carbonaceous particle may be added in an intrinsic form thereof, such as a spherical, tabular, fibrous, tubular, or powder form, to the negative active material, or may be subjected to a spheroidizing treatment as described with the carbonaceous core 110 of the primary particles and then added in a spherical particle form to the negative active material. If spherical particles are added, a spherical particle formed of a material that is identical to or different from the carbonaceous core 110 of the primary particle may be added.

A lithium battery according to an embodiment of the present invention includes a negative electrode including the negative active material; a positive electrode facing the negative electrode; and an electrolyte disposed between the negative electrode and the positive electrode.

The negative electrode may include the negative active material. The negative electrode may be manufactured by using various methods. For example, the negative active material, a binder, and selectively, a conductive agent are mixed in a solvent to prepare a negative active material composition, and then the negative active material composition is molded in a set or predetermined shape. Alternatively, the negative active material composition may be applied on a current collector, such as a copper foil or the like.

The binder included in the negative active material composition may aid a bond between the negative active material and, for example, the conductive agent; and a bond between the negative active material and the current collector. An amount of the binder herein may be, based on 100 parts by weight of the negative active material, in a range of 1 to 50 parts by weight. For example, the amount of the binder may be in a range of 1 to 30 parts by weight, 1 to 20 parts by weight, or 1 to 15 parts by weight, based on 100 parts by weight of the negative active material. Examples of the binder are polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrilebutadienestyrene, phenol resin, epoxy resin, polyethylenetelethphalate, polytetrafluoroethylene, polyphenylsulfide, polyamideimide, polyetherimide, polyethylenesulfone, polyamide, polyacetal, polyphenyleneoxide, polybutylenetelephthalate, ethylene-propylene-diene terpolymer (EPDM), sulfonated EPDM, styrene butadiene rubber, fluoride rubber, various copolymers, and a combination thereof.

The negative electrode may further include a conductive agent that is included selectively to provide a conductive passage to the negative active material to further improve electrical conductivity. As the conductive agent, any material used in a typical lithium battery may be used herein. Examples of the conductive agent are a carbonaceous material such as carbon black, acetylene black, ketjen black, carbon fiber (for example, a vapor phase growth carbon fiber), or the like; a metal such as copper, nickel, aluminum, silver, or the like, each of which may be used in powder or fiber form; a conductive polymer such as a polyphenylene derivative; and a mixture thereof. An amount of the conductive agent may be appropriately controlled. For example, the conductive agent may be added in such an amount that a weight ratio of the negative active material to the conductive agent is in a range of about 99:1 to about 90:10.

The solvent may be N-methylpyrrolidone (NMP), acetone, water, or the like. An amount of the solvent may be in a range of about 1 to about 10 parts by weight based on 100 parts by weight of the negative active material. In one embodiment, if the amount of the solvent is within this range, an active material layer is easily formed.

Also, the current collector may typically be formed in a thickness of about 3 to about 500 μm. The current collector is not particularly limited as long as the current collector does not cause a chemical change in a battery and has conductivity. Examples of a material that forms the current collector are copper; stainless steel; aluminum; nickel′ titanium; calcined carbon; copper and stainless steel that are surface-treated with carbon, nickel, titanium, silver, or the like; an alloy of aluminum and cadmium; etc. Also, an uneven micro structure may be formed on the surface of the current collector to enhance a binding force with the negative active material. Also, the current collector may be used in various forms including a film, a sheet, a foil, a net, a porous structure, a foaming structure, a non-woven structure, etc.

The prepared negative active material composition may be directly coated on a current collector to form a negative electrode plate. Alternatively, the negative active material composition may be cast onto a separate support and then the negative active material film separated from the support is laminated on the current collector, such as a copper foil, to obtain the negative electrode plate.

The negative active material composition may be printed on a flexible electrode substrate to manufacture a printable battery, in addition to the use in manufacturing a lithium battery.

Separately, for the manufacture of a positive electrode, a positive active material composition prepared by mixing a positive active material, a conductive agent, a binder, and a solvent is prepared.

As the positive active material, any lithium-containing metal oxide that is conventionally used in the art is used herein. For example, LiCoO₂, LiMnₓO₂ₓ (where x is 1 or 2), LiNi₁₋ₓMnₓO₂ (where 0<x<1), or LiNi_{1-x-y}CoₓMn_{y}O₂ (where 0≦x≦0.5 and 0≦y≦0.5), or the like may be used. For example, a compound that intercalates and/or deintercalates lithium, such as LiMn₂O₄, LiCoO₂, LiNiO₂, LiFeO₂, V₂O₅, TiS, MoS, or the like, may be used as the positive active material.

The conductive agent, the binder, and the solvent included in preparing the positive active material composition may be identical to those included in the negative active material composition. In some cases, a plasticizer may be further added to the positive active material composition and the negative active material composition to form pores in a corresponding electrode plate. Amounts of the positive active material, the conductive agent, the binder, and the solvent may be the same as used in a conventional lithium battery.

A positive electrode current collector may have a thickness of about 3 to about 500 μm, and may be any of various current collectors that do not cause a chemical change in a battery and has high conductivity. Examples of the positive electrode current collector are stainless steel, aluminum, nickel, titanium, calcined carbon, and aluminum and stainless steel that are surface-treated with carbon, nickel, titanium, silver, or the like. The positive electrode current collector may have an uneven micro structure at its surface to enhance a binding force with the positive active material. Also, the current collector may be used in various forms including a film, a sheet, a foil, a net, a porous structure, a foaming structure, a non-woven structure, etc.

The prepared positive active material composition may be directly coated on the positive electrode current collector to form a positive electrode plate, or may be cast onto a separate support and then a positive active material film, such as a copper foil, separated from the support is laminated on the positive electrode current collector to obtain a positive electrode plate.

The positive electrode may be separated from the negative electrode by a separator, and the separator may be any of various suitable separators that are typically used in a lithium battery. For example, the separator may include a material that has a low resistance to migration of ions of an electrolyte and an excellent electrolytic solution-retaining capability. For example, the separator may include a material selected from the group consisting of glass fiber, polyester, Teflon, polyethylene, polypropylene, polytetrafluoroethylene (PTFE), and a combination thereof, each of which may be nonwoven or woven. The separator may have a pore size of about 0.01 to about 10 μm and a thickness of about 5 to about 300 μm.

A lithium salt-containing non-aqueous based electrolyte includes a non-aqueous electrolyte and lithium. Examples of the non-aqueous electrolyte are a non-aqueous electrolytic solution, an organic solid electrolyte, an inorganic solid electrolyte, etc.

As the non-aqueous electrolytic solution, a non-protogenic organic solvent may be used, and examples of the non-protogenic organic solvent are N-methyl-2-pyrrolidone, propylene carbonate, ethylene carbonate, butylene carbonate, dimethyl carbonate, diethyl carbonate, fluorinated ethylenecarbonate, ethylenemethylenecarbonate, methylpropylcarbonate, ethylpropanoate, methylacetate, ethylacetate, propylacetate, dimethylester gamma-butyloractone, 1,2-dimethoxy ethane, tetrahydrofurane, 2-methyl tetrahydrofurane, dimethylsulfoxide, 1,3-dioxolane, formamide, dimethylformamide, acetonitrile, nitromethane, methyl formic acid, methyl acetatic acid, phosphoric acid trimester, trimethoxy methane, dioxolane derivatives, sulfolanes, methyl sulfolanes, 1,3-dimethyl-2-imidazolidinone, propylene carbonate derivatives, tetrahydrofurane derivatives, ethers, methyl pyrropionic acid, ethyl pyrropionic acid, etc.

Examples of the organic solid electrolyte are a polyethylene derivative, a polyethylene oxide derivative, a polypropylene oxide derivative, a phosphate ester polymer, polyagitation lysine, polyester sulfide, polyvinyl alcohol, poly fluorinated vinylidene, a polymer having an ionic dissociable group, etc.

Examples of the inorganic solid electrolyte are nitrides, halides, and sulfides of Li, such as Li₃N, LiI, Li₅NI₂, Li₃N—LiI—LiOH, LiSiO₄, Li₂SiS₃, Li₄SiO₄, Li₄SiO₄—LiI—LiOH, Li₃PO₄—Li₂S—SiS₂, and the like.

The lithium salt may be any one of various lithium salts that are suitable for use in a lithium battery. As a material that is dissolved in the non-aqueous electrolyte, for example, one or more of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithiumchloroborate, lower aliphatic carbonic acid lithium, 4 phenyl boric acid lithium, imide, etc., may be used.

A lithium battery may be categorized as a lithium ion battery, a lithium ion polymer battery, or a lithium polymer battery, according to a separator used and an electrolyte used. A lithium battery may also be categorized as a cylindrical lithium battery, a square-shaped lithium battery, a coin-shaped lithium battery, or a pouch-shaped lithium battery, according to the shape thereof. A lithium battery may also be categorized as a bulk-size lithium battery batteries or a thin layer-size lithium battery, according to the size thereof. The lithium batteries listed above may also be primary batteries or secondary batteries.

A method of manufacturing the lithium batteries is apparent to one skilled in the art and thus will not be described in detail herein.

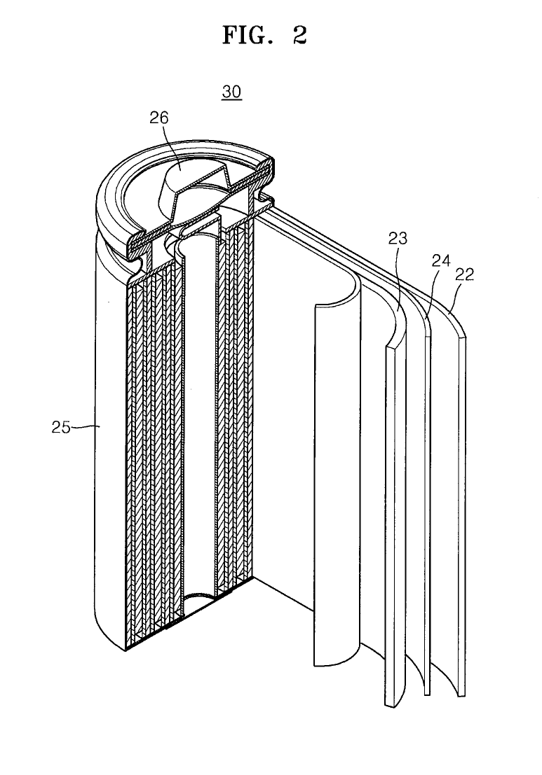

FIG. 2 is a schematic view of a lithium battery 30 according to an embodiment of the present invention.

Referring to FIG. 2, the lithium battery 30 includes a positive electrode 23, a negative electrode 22, and a separator 24 interposed between the positive electrode 23 and the negative electrode 22. The positive electrode 23, the negative electrode 22, and the separator 24 are wound or folded to be housed in a battery case 25. Then, an electrolyte is injected into the battery case 25, followed by sealing the battery case 25 with an encapsulation member 26, thereby completing the manufacture of the lithium battery 30. The battery case 25 may be a cylindrical, rectangular, or thin film battery case. The lithium battery 30 may be a lithium ion battery.

A lithium battery according to an embodiment of the present invention may be used in, in addition to a mobile phone or a portable computer, an application, such as an electric vehicle, that requires high capacity, high power output, and high-temperature driving. Also, the lithium battery may be combined with an existing internal-combustion engine, a fuel cell, a super capacitor, or the like for use in a hybrid vehicle, or the like. Furthermore, the lithium battery may be used in any other suitable applications that require high power output, high voltage, and high-temperature driving.

Hereinafter, exemplary embodiments of the present invention will be described in detail with reference to examples. However, the examples are illustrated for illustrative purposes only and do not limit the scope of the present invention.

### EXAMPLE 1

Si nanowires (SiNWs) were grown on spherical natural graphite (Hitachi Chemical Company) having an average diameter of about 10 μm by vapor-liquid-solid (VLS) growth. Then, the spherical graphite particles were randomly collected and then a circularity thereof was measured by using FPIA-3000. The circularity was in a range of 0.808 to 1.000. The grown SiNWs had an average diameter of about 30 to about 50 nm, an average length of about 1.5 μm, and an amount of SiNW was 7.15 wt %.

3 wt % of coal tar pitch based on 100 w % of the entire active material was coated on a surface of the spherical graphite having the grown SiNWs thereon. The pitch coated spherical graphite was heat treated at the temperature of 800° C. in a nitrogen atmosphere to complete the preparation of a negative active material.

The prepared negative active material and LSR7 (a manufacturer: Hitachi Chemical, a binder that consists of 23 wt % of PAI and 97wt % N-methyl-2-pyrrolidone) as a binder were mixed in a weight ratio of 90:10 and then N-methylpyrrolidone was added thereto to control the viscosity thereof until a solid content thereof reached 30 to 50 wt %, thereby completing preparation of a negative active material slurry. The prepared slurry was coated on a copper foil current collector having a thickness of 10 μm to manufacture a negative electrode plate. The completely coated electrode plate was dried at the temperature of 120° C. for 15 minutes, followed by pressing, thereby completing the manufacture of a negative electrode having a thickness of 60 μm. An Li metal as a reference electrode and a polyethylene separator having a thickness of 20 μm (product name: STAR20, Asahi) were used, and an electrolyte was injected thereto, and the resultant structure was pressed to complete the manufacture of a 2016R type coin cell. In this case, the electrolyte was 0.75 M LiPF₆ dissolved in a mixed solvent of ethylene carbonate (EC), diethyl carbonate (DEC), ethylpropanoate (EP), and fluoro ethylene carbonate (FEC) at a volumetric ratio of EC:DEC:EP:FEC=25.3:3:40.7:38:8. After welding a coin cell, vacuum drying was performed thereon at the temperature of 160° C. for 2 hours to harden the binder and remove moisture.

### EXAMPLE 2

A negative active material and a coin cell were prepared in the same manner as in Example 1, except that in preparing the negative active material, 6 wt % of coal tar pitch based on 100 w % of the entire active material was used for pitch coating.

### EXAMPLE 3

A negative active material and a coin cell were prepared in the same manner as in Example 1, except that in preparing the negative active material, 10 wt % of coal tar pitch based on 100 w % of the entire active material was used for pitch coating.

### EXAMPLE 4

A negative active material and a coin cell were prepared in the same manner as in Example 1, except that in preparing the negative active material, 15 wt % of coal tar pitch based on 100 w % of the entire active material was used for pitch coating.

### COMPARATIVE EXAMPLE 1

A coin cell was prepared in the same manner as in Example 1, except that primary particles prepared by growing SiNWs on spherical graphite were used as a negative active material without pitch coating.

### (Negative Active Material Analysis)

### EVALUATION EXAMPLE 1

### Analysis on Field Emission Scanning Electron Microscope (FE-SEM) Image of Negative Active Material

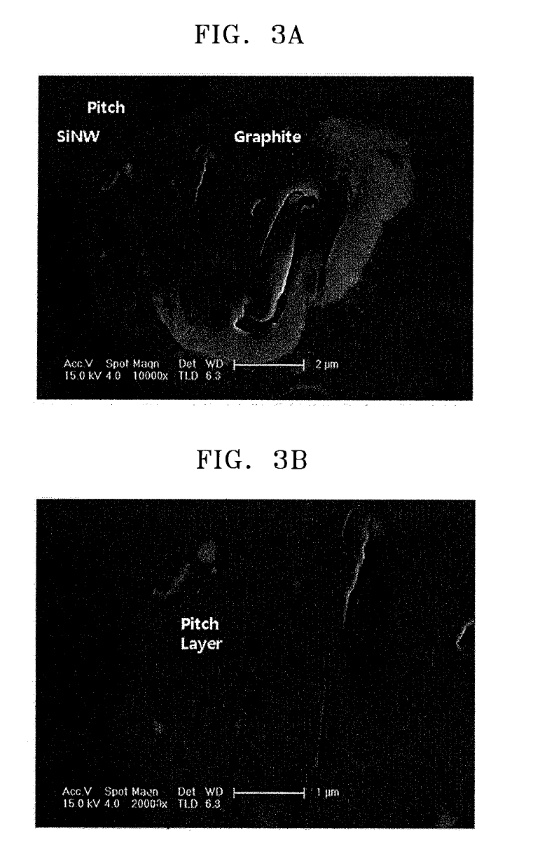

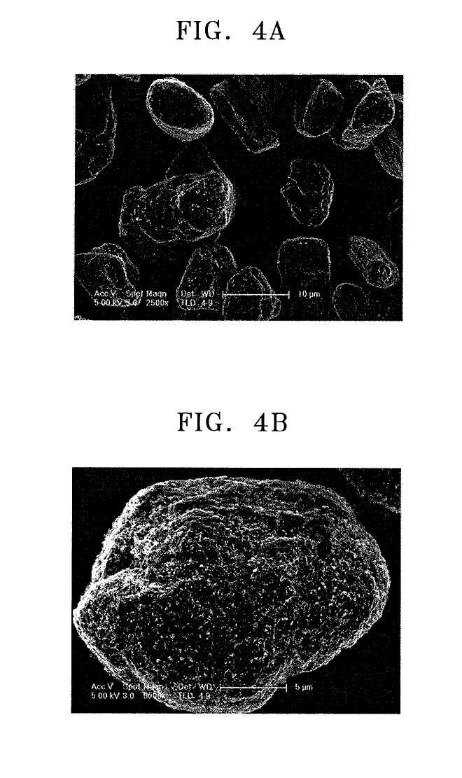

The negative active materials used in preparing the coin cells according to Example 1 and Comparative Example 1 were analyzed by FE-SEM. FE-SEM images of a cross section of the negative active material used in Example 1 are shown in FIGS. 3A and 3B. FE-SEM images of a cross section of the negative active material used in Comparative Example 1 are shown in FIGS. 4A and 4B.

As shown in FIGS. 4A and 4B, regarding the negative active material used in Comparative Example 1, SiNWs grown in spherical graphite are exposed. However, as shown in FIGS. 3A and 3B, regarding the negative active material used in Example 1, a pitch coating layer having a thickness of about 1.5 to 2μm is formed on spherical graphite on which SiNWs are grown and the pitch coating layer surrounds SiNWs.

### EVALUATION EXAMPLE 2

### Raman Spectrum Analysis of Negative Active Material

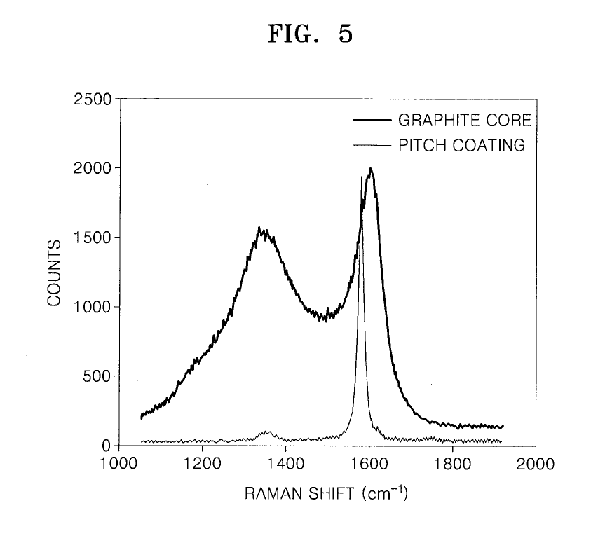

Raman spectrum analysis was performed on a graphite core and a pitch coating layer included in the negative active material used in manufacturing the coin cell of Example 1, and results thereof are shown in FIG. 5.

Raman spectrum analysis on the graphite core and the pitch coating layer were repeatedly performed three times, and the D/G ratio defined as Equation 1 below was calculated and results thereof are shown in Table 1 below.

D/G ratio=[Intensity area of D band peak]/[Intensity area of G band peak] Equation 1

In a Raman spectrum, a D band peak may have its peak center in a frequency number of 1340 to 1360 cm⁻¹, and a G band peak may have its peak center in a frequency number of 1570 to 1590 cm⁻¹.

TABLE 1

| | D/G | | |
|---|---|---|---|
| | Measuring | Measuring | Measuring |
| | once | twice | three times |
| Graphite (core) | 0.1 | 0.1 | 0.1 |
| Pitch (coating layer) | 3.2 | 3.1 | 3.2 |

As shown in Table 1, the D/G ratio of the graphite core was about 0.1, and the D/G ratio of the pitch coating layer was in a range of 3.1 to 3.2. Such a D/G difference may be due to different crystallinity of the graphite core and the pitch coating layer.

### EVALUATION EXAMPLE 3

### Particle Distribution Analysis of Negative Active Material

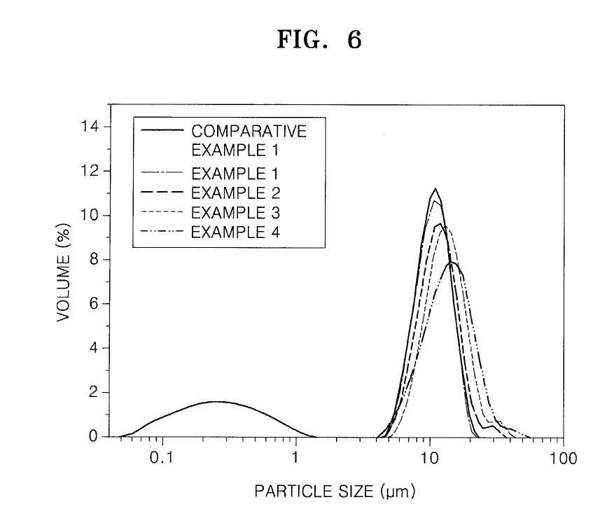

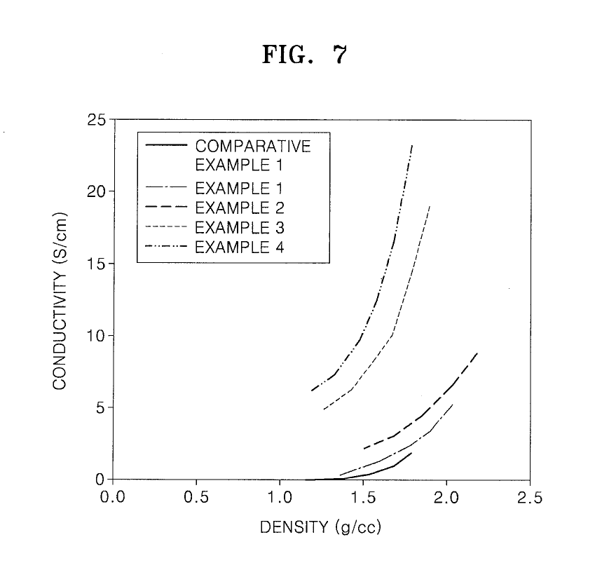

Particle distributions of the negative active materials used in the coin cells of Example 1 and Comparative Example 1 were measured by using a Beckmann culter counter particle distribution analyzer, and results thereof are shown in Table 2 below and FIG. 6.

TABLE 2

| | Pitch coating | | | |
|---|---|---|---|---|
| | amount | D10 | D50 | D90 |
| Comparative | 0 wt % | 0.17 | 11.6 | 18.2 |
| Example 1 | | | | |
| Example 1 | 3 wt % | 7.61 | 12.7 | 16.9 |
| Example 2 | 6 wt % | 8.08 | 12.9 | 19.2 |
| Example 3 | 10 wt % | 7.96 | 13.3 | 23.9 |
| Example 4 | 15 wt % | 8.19 | 15.0 | 35.1 |

[unit: μm]

As shown in Table 2 and FIG. 6, it was confirmed that in the case of the negative active material of Comparative Example 1 in which pitch coating was not performed, SiNWs were separated at a particle size of 1 μm or less, and in the case of the negative active materials of Example 1-3 in which pitch coating was performed, SiNWs were not separated at a particle size of 1 μm or less, and a particle size was increased due to the pitch coating.

### EVALUATION EXAMPLE 3

### Electric Conductivity of Negative Active Material

To measure electric conductivity of the negative active materials used in manufacturing the coin cells of Example 1 and Comparative Example 1, an electric conductivity evaluator (MCP-PD51, Mitsubishi Chemical Company) was used to measure electric conductivity of powder with respect to a pressed density.

The negative active materials used in manufacturing the coin cells of Example 1 and Comparative Example 1 were filled in holders and then pressure was applied thereto to prepare pellets. A mass of each of the pellets was 2.040 g. A distance between electrodes was 3 mm, a radius of an electrode was 0.7 mm, and a radius of each pellet was 10 mm. At each pressure, a resistance (R) of a pattern was measured by using a four-point probe. A specific resistance and an electric conductivity were measured using correction factors in consideration of the thickness and shape of the pattern and the resistance.

Specific resistance measurement formulation: ρ=G×R, G=3.575×t (ρ: specific resistance, R: resistance, G: shape correction factor, and t: pattern thickness)

$$σ = \frac{1}{ρ}$$

σ: electric conductivity, ρ: specific resistance

The electric conductivity evaluation results are shown in FIG. 7. Referring to FIG. 7, the greater the pitch coating amount is, the higher the electric conductivity is. The increased electric conductivity may contribute to improvement in efficiency and lifetime characteristics.

### EVALUATION EXAMPLE 4

### pH of Negative Active Material

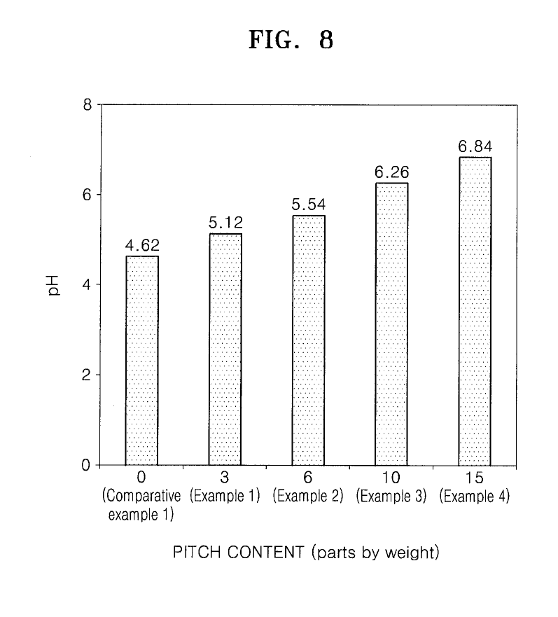

To evaluate pH of the negative active materials used in manufacturing the coin cells of Examples 1 to 4 and Comparative Example 1, 5 wt % negative active material solution was prepared using deionized (DI) water and then stirred and left to sit for 30 minutes. In the solution, graphite was sunk and separated from the SiNWs that were floated. A pH of the solution was measured. The pH data are shown in FIG. 8.

As shown in FIG. 8, the greater the pitch coating amount is, the higher the pH is. SiNWs are acidic so that gelation occurs when a slurry is prepared. However, when pitch coating is performed as in the examples above, SiNWs are neutralized to prevent the slurry gelation and improve proccessability.

### (Cell Properties Evaluation)

### EVALUATION EXAMPLE 5

### Electrode Volumetric Expansion Ratio Measurement

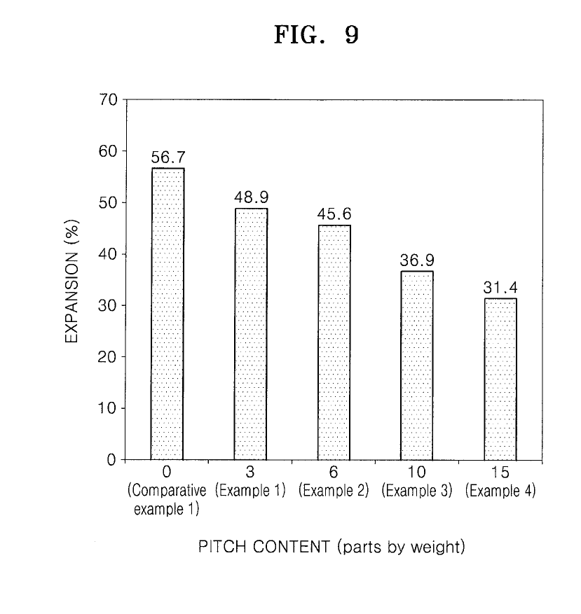

The coin cells of Examples 1-4 and Comparative Example 1 were charged (formation) at a current of 0.05 C and then the coin cells were disassembled to compare a thickness of a negative electrode plate before and after the charging, and a volumetric expansion ratio of the negative electrodes of the coin cells was measured. The results thereof are shown in FIG. 9.

As shown in FIG. 9, the greater the pitch coating amount is, the less the expansion ratio is. This is because SiNWs suppress the expansion. The decreased expansion ratio may contribute to improved charge and discharge efficiency and lifespan improvement.

### EVALUATION EXAMPLE 6

### Charging and Discharging Test

The coin cells of Examples 1-4 and Comparative Example 1 were charged at a current of 40 mA per 1 g of a negative active material until a voltage reached 0.001 V(vs. Li), and then discharged with the same amplitude of current until the voltage reached 3 V (vs. Li). Then, within the same current and voltage ranges, charging and discharging were repeatedly performed 50 times.

This charging and discharging test was performed at room temperature of 25° C. A charge-discharge efficiency (CDE) is defined according to Equation 2 below. A capacity retention ratio (CRR) is defined according to Equation 3 below.

CDE [%]=[discharging capacity in each cycle/charging capacity in the same cycle]×100 Equation 2

CRR [%]=discharging capacity in a 50th cycle/discharging capacity in a first cycle Equation 3

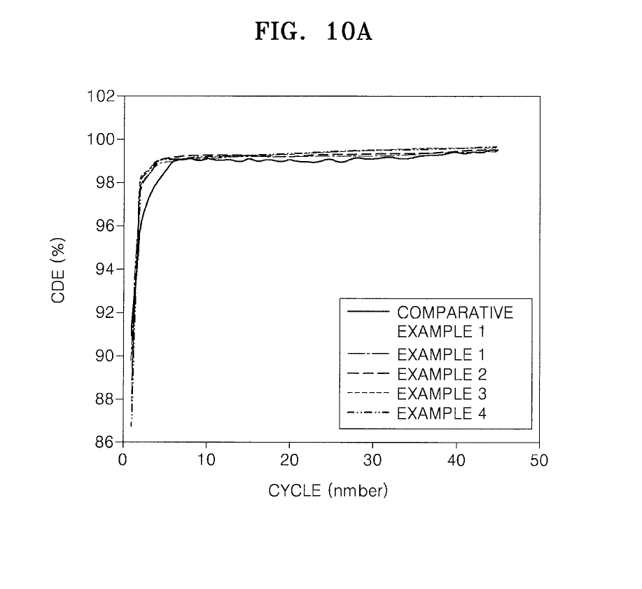

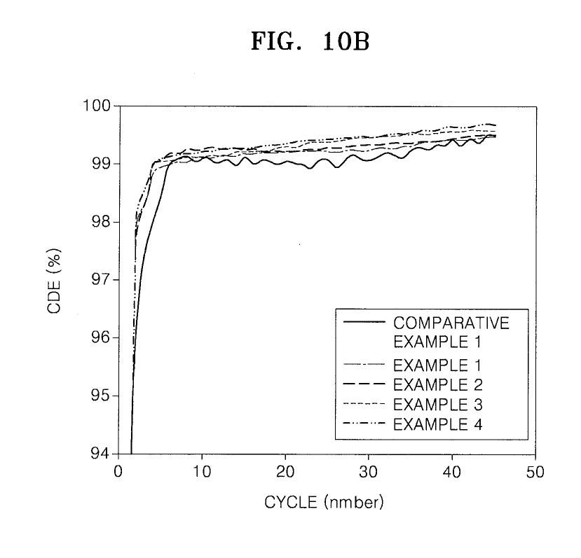

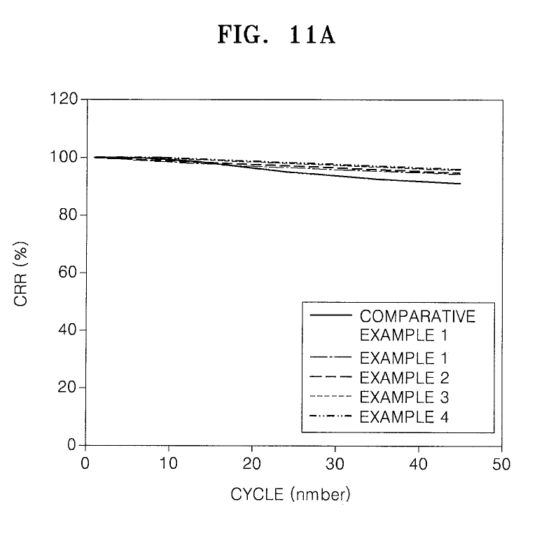

CDE data of the coin cells of Examples 1-4 and Comparative Example 1 are shown in FIG. 10A, and FIG. 10B is an enlarged view of an x-axis of FIG. 10A.

Referring to FIGS. 10A and 10B, the greater the pitch coating amount is, the higher the charge-discharge efficiency is. This is because due to the pitch coating, conductivity of an electrode plate is increased, and also an expansion ratio is controlled and thus, stability of an electrode plate is guaranteed. Also, when pitch coating was performed, an irreversible capacity ratio is reduced and thus, initial efficiency of cycle is improved.

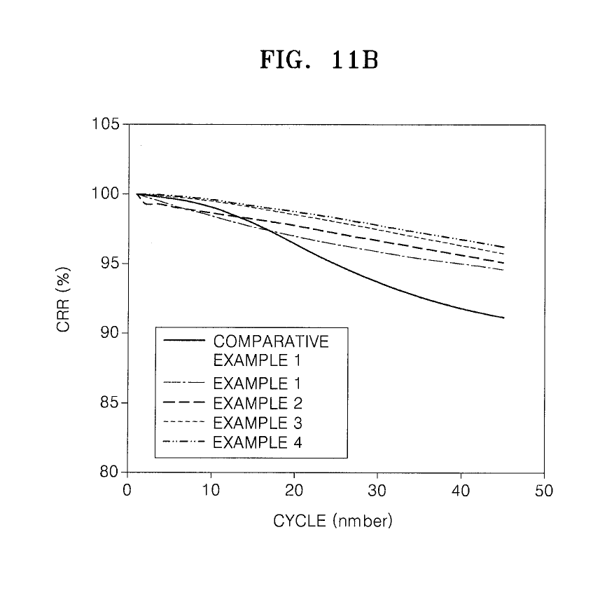

Also, CRR data of the coin cells of Examples 1-4 and Comparative Example 1 are shown in FIG. 11A, and FIG. 11B is an enlarged view of an x-axis of FIG. 11A. Referring to FIGS. 11A and 11B, the greater the pitch coating amount is, the higher the CRR is.

From the charging and discharging results, it is confirmed that due to the pitch coating on the SiNW negative active material prepared using spherical graphite as a base material, electric conductivity of an electrode plate is increased, and also an expansion ratio is controlled and thus stability of the electrode plate is guaranteed, and rate characteristics and lifespan characteristics are improved.

The negative active material may control an expansion ratio during charging and discharging of a lithium battery and may provide conductivity to a negative electrode plate to improve CDE and cycle lifespan characteristics of a lithium battery.

It should be understood that the exemplary embodiments described herein should be considered in a descriptive sense only and not for purposes of limitation. Descriptions of features or aspects within each embodiment should typically be considered as available for other similar features or aspects in other embodiments. That is, while the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A negative active material comprising a primary particle, the primary particle comprising:
a crystalline carbonaceous core with silicon-based nanowires on a surface thereof; and
an amorphous carbonaceous coating layer coated on the crystalline carbonaceous core so as not to expose at least a portion of the silicon-based nanowires.

2. The negative active material of claim 1, wherein at least 50 vol % of the silicon-based nanowires is embedded in the amorphous carbonaceous coating layer.

3. The negative active material of claim 1, wherein a thickness of the amorphous carbonaceous coating layer is in a range of about 0.1 to about 10 μm.

4. The negative active material of claim 1, wherein a D/G ratio of the amorphous carbonaceous coating layer is 0.31 or more, and wherein the D/G ratio is a ratio of a D (defect) band peak intensity area with respect to a G (graphite) band peak intensity area in a Raman spectrum.

5. The negative active material of claim 1, wherein the amorphous carbonaceous coating layer comprises an amorphous carbon selected from the group consisting of soft carbon (cold calcination carbon), hard carbon, pitch carbide, mesophase carbide, calcined corks, and combinations thereof.

6. The negative active material of claim 1, wherein an amount of the amorphous carbonaceous coating layer is in a range of about 0.1 to about 30 wt % based on the primary particle.

7. The negative active material of claim 1, wherein the crystalline carbonaceous core has a circularity of about 0.2 to about 1.

8. The negative active material of claim 1, wherein a D/G ratio of the crystalline carbonaceous core is 0.3 or less, and wherein the D/G ratio is a ratio of a D (defect) band peak intensity area with respect to a G (graphite) band peak intensity area in a Raman spectrum.

9. The negative active material of claim 1, wherein the crystalline carbonaceous core comprises at least one selected from the group consisting of natural graphite, artificial graphite, expandable graphite, graphene, carbon black, and fullerene soot.

10. The negative active material of claim 1, wherein an average particle diameter of the crystalline carbonaceous core is in a range of about 1 to about 30 μm.

11. The negative active material of claim 1, wherein the silicon-based nanowires comprise at least one selected from the group consisting of Si, SiOx (0<x≦2), and Si—Z alloys (where Z is an alkali metal, an alkali earth metal, a Group 13 element, a Group 14 element, a transition metal, a rare earth element, or a combination thereof and is not Si).

12. The negative active material of claim 1, wherein the silicon-based nanowires are Si nanowires.

13. The negative active material of claim 1, wherein each of the silicon-based nanowires independently has a diameter of about 10 to about 500 nm and a length of about 0.1 to about 100 μm.

14. The negative active material of claim 1, wherein the silicon-based nanowires are directly grown on the crystalline carbonaceous core.

15. The negative active material of claim 14, wherein the silicon-based nanowires are grown in the presence or absence of at least one metal catalyst selected from the group consisting of Pt, Fe, Ni, Co, Au, Ag, Cu, Zn, and Cd.

16. The negative active material of claim 1, wherein based on a total amount of the crystalline carbonaceous core and the silicon-based nanowires, an amount of the crystalline carbonaceous core is in a range of about 60 to about 99 wt % and an amount of the silicon-based nanowires is in a range of about 1 to about 40 wt %.

17. The negative active material of claim 1, wherein the negative active material further comprises a carbonaceous particle comprising at least one selected from the group consisting of natural graphite, artificial graphite, expandable graphite, graphene, carbon black, fullerene soot, carbon nanotubes, and carbon fiber.

18. The negative active material of claim 17, wherein the carbonaceous particle is in a spherical, tabular, fibrous, tubular, or powder form.

19. A lithium battery comprising:
a negative electrode comprising the negative active material of claim 1;
a positive electrode facing the negative electrode; and
an electrolyte between the negative electrode and the positive electrode.

20. The lithium battery of claim 19, wherein the negative electrode further comprises at least one binder selected from the group consisting of polyvinylidenefluoride, polyvinylidenechloride, polybenzimidazole, polyimide, polyvinylacetate, polyacrylonitrile, polyvinylalcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrilebutadienestyrene, phenol resin, epoxy resin, polyethylenetelethphalate, polytetrafluoroethylene, polyphenylsulfide, polyamideimide, polyetherimide, polyethylenesulfone, polyamide, polyacetal, polyphenyleneoxide, polybutylenetelephthalate, ethylene-propylene-diene terpolymer (EPDM), sulfonated EPDM, styrene butadiene rubber, and a fluoride rubber.

21. The lithium battery of claim 20, wherein an amount of the binder is in a range of about 1 to about 50 parts by weight based on 100 parts by weight of the negative active material.

22. The lithium battery of claim 19, wherein the negative electrode further comprises at least one conductive agent selected from the group consisting of carbon black, acetylene black, ketjen black, carbon fiber, copper, nickel, aluminum, silver, and a conductive polymer.
